(19) United States
(12) Patent Application Publication
(10) Pub. No.: US 2026/0177954 A1
(43) Pub. Date: Jun. 25, 2026

(54) HEATING DEVICE, FIXING DEVICE AND IMAGE FORMING APPARATUS

(71) Applicant: Hiromasa TAKAGI, Tokyo (JP)

(72) Inventor: Hiromasa TAKAGI, Tokyo (JP)

(21) Appl. No.: 19/357,134

(22) Filed: Oct. 14, 2025

(30) Foreign Application Priority Data
Dec. 23, 2024 (JP) 2024-226334

(51) Int. Cl. G03G 15/20

(52) U.S. Cl. CPC G03G 15/2053; G03G 15/2064; G03G 2215/2035

(57) ABSTRACT

A heating device includes a pressure rotator, a heating rotator, and a heater extending in a longitudinal direction and having a central region and an end region adjacent to the central region in the longitudinal direction. The heater includes a first strip-shaped resistor and a second strip-shaped resistor that extend in the longitudinal direction and form a constant gap therebetween. The first strip-shaped resistor has a first width in the end region and a second constant width in the central region. The second strip-shaped resistor has a third width in the end region and a fourth constant width in the central region. The first and third widths vary according to their positions in the longitudinal direction, respectively. A sum of the first width and the third width at a position in the longitudinal direction is equal to a sum of the second constant width and the fourth constant width.

### CROSS-REFERENCE TO RELATED APPLICATIONS

This patent application is based on and claims priority pursuant to 35 U.S.C. § 119(a) to Japanese Patent Application No. 2024-226334, filed on Dec. 23, 2024, in the Japan Patent Office, the entire disclosure of which is hereby incorporated by reference herein.

### BACKGROUND

### Technical Field

The present disclosure relates to a heating device including a strip-shaped resistor. In addition, the present disclosure relates to a fixing device and an image forming apparatus that include the heating device.

### Related Art

An image forming apparatus such as a copier or a printer includes a fixing device as an example of a heating device. The fixing device includes a pressure rotator and a heating rotator such as a fixing belt. The pressure rotator and the heating rotator form a nip between the pressure rotator and the heating rotator. A sheet-shaped member to be heated passes through the nip to fix an image onto the member. The fixing device includes a strip-shaped resistor disposed inside the loop of the fixing belt to heat the fixing belt.

### SUMMARY

The present disclosure described herein provides a heating device including a pressure rotator, a heating rotator, and a heater. The heating rotator has a loop and forms a nip between the pressure rotator and the heating rotator. A sheet-shaped member passes through the nip in a sheet conveyance direction. The heater is inside the loop of the heating rotator and extends in a longitudinal direction orthogonal to a short-side direction parallel to the sheet conveyance direction. The heater has a central region in the longitudinal direction and an end region adjacent to the central region in the longitudinal direction. The heater includes a first strip-shaped resistor and a second strip-shaped resistor that extend in the longitudinal direction. The first strip-shaped resistor has a first width in the short-side direction in the end region and a second width in the short-side direction in the central region. The first width varies according to a position in the longitudinal direction, and the second width is constant in the longitudinal direction. The second strip-shaped resistor has a third width in the short-side direction in the end region and a fourth width in the short-side direction in the central region. The third width varies according to the position in the longitudinal direction. The fourth width is constant in the longitudinal direction. A gap between the first strip-shaped resistor and the second strip-shaped resistor in the short-side direction is constant in the longitudinal direction. A sum of the first width and the third width at the position in the longitudinal direction in the end region is equal to a sum of the second width and the fourth width in the central region.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming apparatus;

FIG. 2 is a schematic diagram illustrating a basic configuration of a fixing device;

FIG. 3 is a plan view of a heater in the fixing device of FIG. 2;

FIG. 4 is a cross-sectional view of a part around a fixing nip of the fixing device of FIG. 2;

FIG. 5 is a plan view of an end portion of a heater of a fixing device according to a first embodiment;

FIG. 6A is a plan view of an end portion of a heater of a fixing device according to a second embodiment;

FIG. 6B is a graph illustrating a pressure distribution of a fixing nip in a sheet conveyance direction;

FIG. 6C is a schematic diagram illustrating a fixing nip in the fixing device of FIG. 6A;

FIG. 7A is a cross-sectional view of a part around a fixing nip in a fixing device according to a third embodiment;

FIG. 7B is a schematic diagram of the fixing nip of FIG. 7A in which a thickness of a fixing belt is enlarged to highlight the thickness of the fixing belt;

FIG. 8 is a plan view of an end portion of a heater of a fixing device according to a fourth embodiment;

FIG. 9(a) is a plan view of an end portion of a heater of a fixing device according to a comparative example;

FIG. 9(b) is a schematic diagram illustrating regions in FIG. 9(a); and

FIG. 9(c) is a schematic diagram illustrating a part of the widest sheet and a part of the second widest sheet that are related to the regions of FIG. 9(a).

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

With reference to the drawings, descriptions are given below of embodiments of the present disclosure. In the drawings illustrating the following embodiments, like reference signs are allocated to elements having the same function or shape and redundant descriptions thereof are omitted below.

An overall configuration of an image forming apparatus is described below.

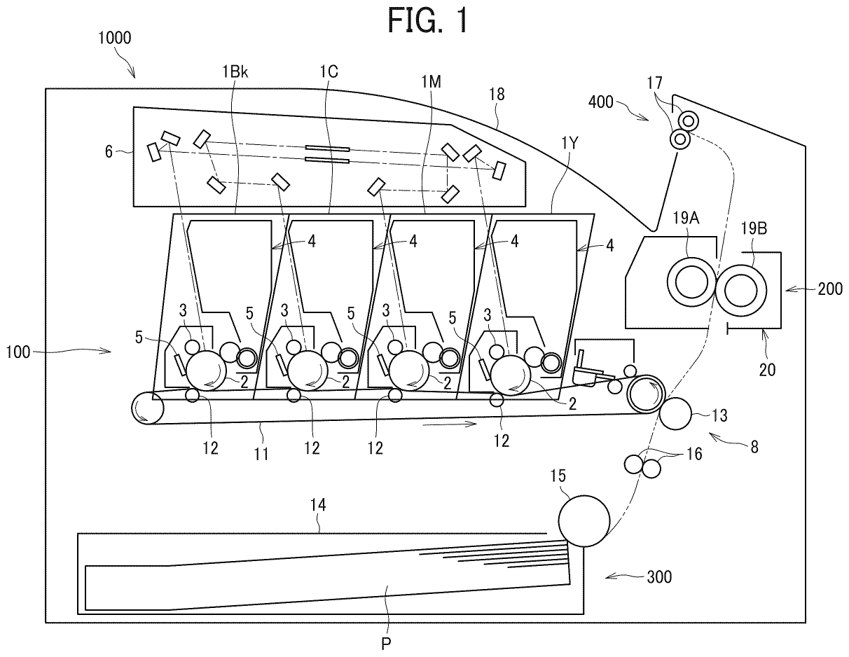

FIG. 1 is a schematic diagram illustrating a configuration of an image forming apparatus 1000 according to the embodiments. In the following description, the “image forming apparatus” includes a printer, a copier, a facsimile machine, or a multifunction peripheral having at least two of printing, copying, scanning, and facsimile functions.

The term “image formation” used in the following description includes the formation of images with meanings such as characters and figures and the formation of images with no meanings such as patterns. With reference to FIG. 1, a description is given below of the overall configuration and operation of the image forming apparatus 1000. As illustrated in FIG. 1, the image forming apparatus 1000 includes an image forming section 100, a fixing section 200, a sheet feeder 300, and a sheet ejection section 400.

The image forming section 100 is described below.

The image forming section 100 forms an image on a sheet as a recording medium. The image forming section 100 includes four image forming units 1Y, 1M, 1C, and 1Bk, an exposure device 6, and a transfer device 8. Each of the four image forming units 1Y, 1M, 1C, and 1Bk includes a photoconductor 2, a charger 3, a developing device 4, and a cleaner 5.

The photoconductor 2 bears an electrostatic latent image on the surface of the photoconductor 2 and rotates. Examples of the photoconductor 2 includes an endless-shaped photoconductor belt in addition to a drum-shaped photoconductor. The drum-shaped photoconductor 2 is, for example, an inorganic photoconductor such as amorphous silicon or selenium, or an organic photoconductor such as titanyl phthalocyanine.

As the organic photoconductor, there are a laminated type photoconductor and a single-layer type photoconductor. The laminated type photoconductor has a laminated structure containing a layer (a charge generation layer) in which charge-generating materials such as non-metallic phthalocyanine or titanyl phthalocyanine are dispersed in a binder resin and a layer (a charge transport layer) in which charge transport materials are dispersed in a binder resin. These layers are stacked on a support such as an aluminum drum. The single-layer type photoconductor has a single-layer structure with a photosensitive layer containing both charge-generating materials and charge transport materials dispersed in a binder resin on a support. In the single-layer type photoconductor, it is also possible to add hole transport agents and electron transport agents as charge transport materials to the photosensitive layer. Additionally, the option exists to include an undercoat layer between the support and either the charge-generation layer in the laminated type photoconductor or the photosensitive layer in the single-layer type photoconductor.

The charger 3 charges the surface of the photoconductor 2. The charging system of the charger 3 is not limited to a particular system as long as the charger 3 applies a voltage to the surface of the photoconductor 2 to uniformly charge the surface of the photoconductor 2. The charging system of the charger 3 can be selected as appropriate depending on the purpose. Specifically, examples of the charger 3 include a contact type charger such as a conductive or semiconductive charging roller, a magnetic brush, a fur brush, a film, or a rubber blade, and a non-contact type charger using corona discharge.

The developing device 4 supplies toner as the developer to the electrostatic latent image on the photoconductor 2 to form a toner image. The developing devices 4 accommodate toners (developers) of different colors such as yellow, magenta, cyan, and black in the image forming units 1Y, 1M, 1C, and 1Bk, respectively, corresponding to color separation components of a color image.

The cleaner 5 removes the toner and other foreign matters remaining on the photoconductor 2. Examples of the cleaner 5 include a cleaning blade disposed to be in contact with the surface of the photoconductor 2.

The exposure device 6 exposes the charged surface of the photoconductor 2 to form the electrostatic latent image on the surface of the photoconductor 2.

The exposure system of the exposure device 6 is not limited to a particular system as long as the exposure device 6 can expose the charged surface of the photoconductor 2 and can be appropriately selected depending on the purpose. Specific examples of the exposure device include various exposure devices such as a copying optical system, a rod lens array system, a laser optical system, a liquid crystal shutter optical system, and an LED optical system.

The transfer device 8 transfers the toner image onto the sheet. The transfer device 8 includes an intermediate transfer belt 11, primary transfer rollers 12, and a secondary transfer roller 13.

The intermediate transfer belt 11 is an endless belt stretched by a plurality of support rollers. Four primary transfer rollers 12 are disposed inside the loop of the intermediate transfer belt 11.

Each of the primary transfer rollers 12 is in contact with the corresponding photoconductor 2 via the intermediate transfer belt 11 to form a primary transfer nip between the intermediate transfer belt 11 and each photoconductor 2. On the other hand, the secondary transfer roller 13 contacts an outer circumferential surface of the intermediate transfer belt 11 to form a secondary transfer nip between the secondary transfer roller 13 and the intermediate transfer belt 11.

An elastic intermediate transfer belt may be used as the intermediate transfer belt 11. The elastic intermediate transfer belt may include, for example, a rigid base layer having relatively flexibility and a flexible elastic layer layered on the base layer. In addition, the intermediate transfer belt 11 may include a guide on the inner circumferential surface of the intermediate transfer belt to prevent the intermediate transfer belt 11 from meandering.

The fixing section 200 is described below.

The fixing section 200 includes a fixing device 20 that heats the sheet to fix the image on the sheet. The fixing device 20 includes a pair of rotators 19A and 19B contacting each other and a heater heating at least one of the pair of rotators 19A and 19B.

The sheet feeder 300 is described below.

The sheet feeder 300 supplies the sheet to the image forming section 100. The sheet feeder 300 includes a sheet tray 14 to store sheets P as heated members and a feed roller 15 to feed the sheet P from the sheet tray 14. Thus, the secondary transfer nip is formed between the secondary transfer roller 13 and the intermediate transfer belt 11.

Examples of the “heated member” include not only a sheet of paper but also an overhead projector (OHP) transparency sheet, a fabric, a metallic sheet, a plastic film, and a prepreg sheet including carbon fibers previously impregnated with resin. Examples of the “sheet” further include thick paper, a postcard, an envelope, thin paper, coated paper (e.g., coat paper and art paper), and tracing paper, in addition to plain paper.

The sheet ejection section 400 is described below.

The sheet ejection section 400 ejects the sheet P to the outside of the image forming apparatus 1000. The sheet ejection section 400 includes an output roller pair 17 to eject the sheet P to the outside of the image forming apparatus 1000 and an output tray 18 to place the sheet P ejected by the output roller pair 17.

An image forming operation is described below.

With continued reference to FIG. 1, the image forming operation of the image forming apparatus 1000 is described below. The image forming operation is started in response to an instruction from an operation panel or external terminals. In each of the image forming units 1Y, 1M, 1C, and 1Bk, the photoconductor 2 starts rotating.

Subsequently, the charger 3 uniformly charges the surface of the photoconductor 2 to a high electric potential. Based on image data of a document read by a document reading device or print data instructed to print by a terminal, the exposure device 6 exposes the charged surface of each of the photoconductors 2.

As a result, the electric potential at an exposed portion on the surface of each of the photoconductors 2 is decreased. Thus, the electrostatic latent image is formed on the surface of each of the photoconductors 2. The developing devices 4 supply toners to the photoconductors 2, respectively, to form toner images of different colors on the photoconductors 2, respectively.

As the photoconductors 2 rotate, the toner images on the photoconductors 2 reach primary transfer nips defined by the positions of the primary transfer rollers 12, respectively. At the primary transfer nips, the toner images are transferred from the photoconductors 2 onto the intermediate transfer belt 11 driven to rotate so as to be sequentially superimposed on one another.

Thus, the full-color toner image is formed on the intermediate transfer belt 11. The image forming operation is not limited to the above-described full color image forming operation that uses all four image forming units 1Y, 1M, 1C, and 1Bk. Alternatively, the image forming apparatus 1000 can form a monochrome toner image by using any one of the four image forming units 1Y, 1M, 1C, and 1Bk, or can form a bicolor toner image or a tricolor toner image by using two or three of the image forming units 1Y, 1M, 1C, and 1Bk.

After the toner image is transferred to the intermediate transfer belt 11, the cleaner 5 removes residual toner remaining on the photoconductor 2 from the surface of the photoconductor 2. As a result, the cleaner 5 removes foreign matter such as residual toner on the photoconductor 2.

The full-color toner image transferred to the intermediate transfer belt 11 is conveyed to the secondary transfer nip defined by the secondary transfer roller 13 in accordance with rotation of the intermediate transfer belt 11. At the secondary transfer nip, the full-color toner image is transferred from the intermediate transfer belt 11 onto the sheet P.

The sheet P is fed from the sheet feeder 300. After the start of the image forming operation, the feed roller 15 rotates to feed the sheet P from the sheet tray 14.

Before the sheet P reaches the secondary transfer nip, the sheet P fed from the sheet tray 14 is brought into contact with a timing roller pair 16 and temporarily stopped. After the sheet P is temporarily stopped, the timing roller pair 16 is rotated at a predetermined time to convey the sheet P to the secondary transfer nip in synchronization with the full-color toner image formed on the intermediate transfer belt 11 reaching the secondary transfer nip. As a result, the full-color toner image is transferred to the sheet P.

The sheet P bearing the full-color toner image is conveyed to the fixing section 200. In the fixing section 200, the sheet P passes between the pair of rotators 19A and 19B, and thus the full-color toner image on the sheet P is heated and pressed to fix the full-color toner image to the sheet P.

Then, the sheet P bearing the fixed toner image is conveyed to the sheet ejection section 400. In the sheet ejection section 400, the output roller pair 17 ejects the sheet P onto the output tray 18. Thus, a series of image forming operations is completed.

The basic configuration of the fixing device 20 is described below.

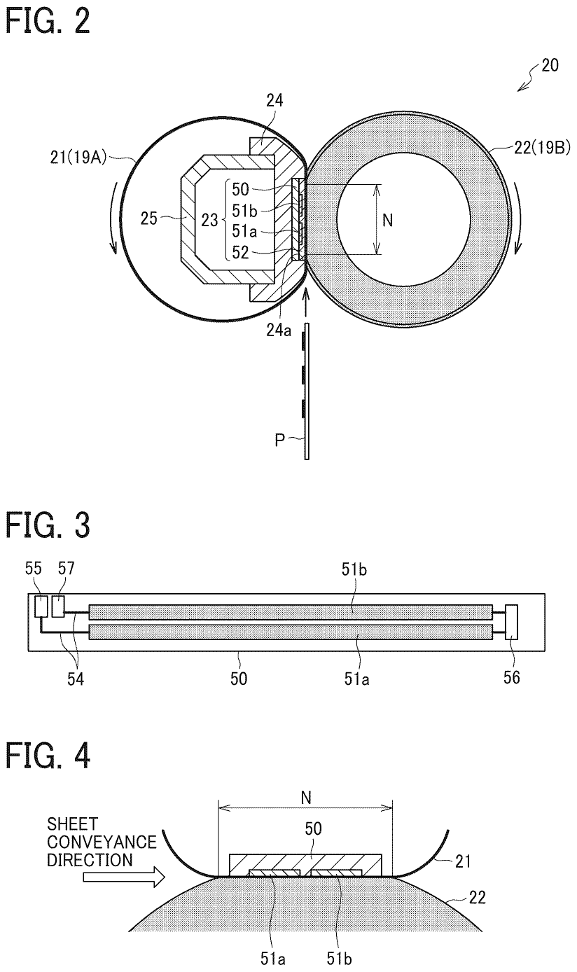

FIG. 2 is a schematic diagram illustrating the basic configuration of the fixing device 20. As illustrated in FIG. 2, the fixing device 20 includes a heater 23, a heater holder 24, and a stay 25 in addition to the pair of rotators 19A and 19B.

The pair of rotators 19A and 19B includes a first rotator 19A that is a fixing belt 21 disposed to contact an unfixed toner image on a surface of the sheet P. The fixing belt 21 is an example of a heating rotator. The pair of rotators 19A and 19B includes a second rotator 19B that is a pressure roller 22 disposed to face the fixing belt 21. The pressure roller 22 is an example of a pressure rotator.

A pressure member such as a spring presses the fixing belt 21 and the pressure roller 22 to be in contact with each other. As a result, a fixing nip N is formed between the fixing belt 21 and the pressure roller 22.

The fixing belt 21 is an endless belt including a tubular base and a release layer on an outer circumferential surface of the base. The base is made of metal such as nickel or stainless steel or resin such as polyimide.

The release layer is made of, for example, tetrafluoroethylene-perfluoroalkylvinylether copolymer (PFA), polytetrafluoroethylene (PTFE), polyimide, polyetherimide, or polyether sulfide (PES). The release layer of the fixing belt 21 facilitates the separation of toner contained in the toner image from the fixing belt 21 and prevents the sheet P from adhering to and wrapping around the fixing belt 21.

The fixing belt 21 may include an elastic layer between the base and the release layer. Examples of the material of the elastic layer include rubber such as silicone rubber, silicone rubber foam, and fluororubber. The elastic layer of the fixing belt 21 prevents the fixing belt 21 from forming slight surface asperities, thus facilitating uniform conduction of heat to the toner image on the sheet P to enhance fixing quality.

The pressure roller 22 includes a solid or hollow cored bar, an elastic layer on the outer circumferential surface of the cored bar, and a release layer on the outer circumferential surface of the elastic layer. The cored bar is made of metal such as iron.

Examples of the material of the elastic layer include silicone rubber, silicone rubber foam, and fluororubber. The release layer is made of fluororesin such as PFA or PTFE.

The heater 23 heats the fixing belt 21. The heater 23 is disposed inside the loop of the fixing belt 21 as the heating rotator. The heater 23 has a plate shape or a planar shape and contacts the inner circumferential surface of the fixing belt 21.

At a position where the fixing belt 21 faces the pressure roller 22, the heater 23 contacts the inner circumferential surface of the fixing belt 21 to form the fixing nip N between the fixing belt 21 and the pressure roller 22. The heater 23 may be in direct contact with the inner circumferential surface of the fixing belt 21 or may be in indirect contact with the inner circumferential surface of the fixing belt 21 via a low-friction slide sheet. In the present specification, unless otherwise specified, the meaning of “contact” includes direct contact and indirect contact. In the direct contact, a first member is in contact with a second member via no member. In the indirect contact, a third member is in contact with a fourth member via a fifth member.

The heater 23 includes a base 50, strip-shaped resistors 51a and 51b, and an insulation layer 52. The strip-shaped resistors 51a and 51b are disposed on the base 50 and covered with the insulation layer 52.

When power is supplied to the strip-shaped resistors 51a and 51b, the strip-shaped resistors 51a and 51b generate heat. The heat is transferred to the inner circumferential surface of the fixing belt 21 via the insulation layer 52 to heat the fixing belt 21. Alternatively, the heater 23 may be turned inside out so that the base 50 is in contact with the inner circumferential surface of the fixing belt 21. In this case, since the heat of the strip-shaped resistors 51a and 51b is transmitted to the fixing belt 21 through the base 50, it is preferable that the base 50 be made of a material with high thermal conductivity.

The base 50 is made of material having heat resistance and insulation properties, such as ceramic such as alumina or aluminum nitride, or non-metal material such as glass or mica. Interposing another insulation layer between the base 50 and the strip-shaped resistors 51a and 51b enables using conductive material such as metal as the material of the base 50.

Low-cost aluminum or stainless steel is favorable as the metal material of the base 50.

To reduce the temperature unevenness of the heater 23 and enhance image quality, the base 50 may be made of material having high thermal conductivity, such as copper, graphite, or graphene. Graphene is formed by bonding of carbon atoms and has a sheet shape.

The strip-shaped resistors 51a and 51b are formed by, for example, screen-printing. The strip-shaped resistors 51a and 51b are produced by, for example, mixing silver-palladium (AgPd) and glass powder into a paste. The paste is coated on the base 50 by screen printing. Subsequently, the base 50 is fired to form the strip-shaped resistors 51a and 51b.

The material of the strip-shaped resistors 51a and 51b may contain a resistance material, such as silver alloy (e.g., AgPt) or ruthenium oxide (RuO₂) in addition to silver-palladium. The insulation layer 52 may be made of, for example, heat-resistant glass.

The heater holder 24 holds the heater 23. The heater holder 24 accommodates the heater 23 in a recess 24a to restrict the movement of the heater 23 in the vertical direction in FIG. 2 and the direction orthogonal to the paper surface in which FIG. 2 is drawn.

Since the heater holder 24 is heated to a high temperature by heat from the heater 23, the heater holder 24 is preferably made of a heat resistant material. In particular, the heater holder 24 made of heat-resistant resin having low thermal conduction, such as a liquid crystal polymer (LCP), reduces unnecessary heat transfer from the heater 23 to the heater holder 24, thus increasing the heating efficiency of the heater 23.

The stay 25 supports the heater holder 24. The stay 25 supports a stay side face of the heater holder 24. The stay side face is opposite a nip side face of the heater holder 24. The nip side face faces the pressure roller 22. Accordingly, the stay 25 prevents the heater 23 from being bent by a pressing force of the pressure roller 22. As a result, the fixing nip N having a uniform width is formed between the fixing belt 21 and the pressure roller 22. The stay 25 is preferably made of iron-based metal such as steel use stainless (SUS) or steel electrolytic cold commercial (SECC) to enhance the rigidity.

The fixing device 20 operates as follows.

When the image forming operation starts, a driver starts driving to rotate the pressure roller 22 in a direction indicated by an arrow in FIG. 2, and the rotation of the pressure roller 22 rotates the fixing belt 21. A power source starts supplying power to the heater 23, and the heater 23 generates heat to heat the fixing belt 21.

After the temperature of the fixing belt 21 reaches a specified target temperature, the sheet P bearing the unfixed image is conveyed to the fixing nip N between the fixing belt 21 and the pressure roller 22. As a result, the unfixed toner image on the sheet P is heated and pressed to be fixed on the sheet P. The sheet P is ejected from the fixing nip N and conveyed to the sheet ejection section 400.

A basic heater configuration is described below.

FIG. 3 is a plan view of a basic configuration of the heater 23. As illustrated in FIG. 3, the heater 23 includes a pair of end electrodes 55 and 57, a junction electrode 56, and multiple power supply lines 54 in addition to the base 50, a first strip-shaped resistor 51a and a second strip-shaped resistor 51b, and the insulation layer 52.

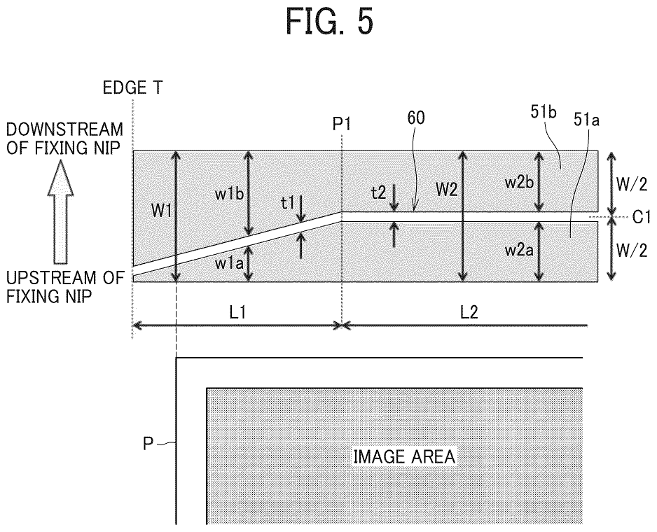

The base 50 is a longitudinal plate arranged to extend in the longitudinal direction X of the fixing belt 21. The first strip-shaped resistor 51a and the second strip-shaped resistor 51b extend in the longitudinal direction of the base 50 (that is an X direction) and are arranged with a gap (corresponding to a gap 60 in FIG. 5) between the first strip-shaped resistor 51a and the second strip-shaped resistor 51b in a direction orthogonal to the longitudinal direction.

The gap between neighboring strip-shaped resistors 51a and 51b is preferably 0.2 mm or more, more preferably 0.4 mm or more from the viewpoint of maintaining the insulation between the strip-shaped resistors 51a and 51b. In addition, the gap between the strip-shaped resistors 51a and 51b adjacent to each other is preferably 5 mm or less, and is more preferably 1 mm or less, from the viewpoint of reducing temperature unevenness in the longitudinal direction because a too large gap between the strip-shaped resistors 51a and 51b adjacent to each other easily causes a temperature drop in the gap.

The pair of end electrodes 55 and 57 are disposed on an end portion of the base 50 in the longitudinal direction of the base 50. The end electrode 55 is connected to the first strip-shaped resistor 51a via one of the multiple power supply lines 54, and the end electrode 57 is connected to the strip-shaped resistor 51b via one of the multiple power supply lines 54.

In this case, the strip-shaped resistors 51a and 51b are electrically connected in series to the end electrodes 55 and 57. The arrangement, number, shape of each of the strip-shaped resistors 51a and 51b, the end electrodes 55 and 57, and the power supply lines 54 are not limited to the example illustrated in FIG. 3 and may be appropriately changed.

The power supply lines 54 are covered with the insulation layer 52 in the same manner as the strip-shaped resistors 51a and 51b in order to obtain insulation and durability. However, the insulation layer 52 does not cover the end electrodes 55 and 57 to expose the end electrodes 55 and 57 as power supply terminals so as to be connected to the connectors. Connecting the connectors to the end electrodes 55 and 57 enables the power source (an alternating-current (AC) power source) disposed in the body of the image forming apparatus to supply power to the strip-shaped resistors 51a and 51b.

As illustrated in FIG. 4, the first strip-shaped resistor 51a is disposed to face an upstream portion of the fixing nip in a sheet conveyance direction, and the second strip-shaped resistor 51b is disposed to face a downstream portion of the fixing nip in the sheet conveyance direction. The first strip-shaped resistor 51a and the second strip-shaped resistor 51b have the same constant thickness. In other words, the first strip-shaped resistor 51a is disposed upstream from the second strip-shaped resistor 51b in the sheet conveyance direction. Each of the first strip-shaped resistor 51a and the second strip-shaped resistor 51b has a constant thickness that is constant along the sheet conveyance direction.

A first embodiment is described below.

FIG. 5 is a plan view of an end portion of the heater of the fixing device according to the first embodiment. In the following description, the sheet conveyance direction in the fixing nip is referred to as a short-side direction, and a direction orthogonal to the short-side direction is defined as the longitudinal direction. In other words, the short-side direction is parallel to the sheet conveyance direction. A gap 60 is formed between the first strip-shaped resistor 51a and the second strip-shaped resistor 51b. The gap 60 has a width t1 and a width t2 that are lengths in the short-side direction, and each of the widths t1 and t2 is constant in the longitudinal direction.

The first strip-shaped resistor 51a and the second strip-shaped resistor 51b have an end region L1 and a central region L2 that are adjacent to each other in the longitudinal direction. In other words, the heater 23 has the central region L2 and the end region L1 adjacent to the central region L2 in the longitudinal direction. In the end region L1, the first strip-shaped resistor 51a has a first width w1a in the short-side direction, and the first width w1a varies according to a position in the longitudinal direction. In the central region L2, the first strip-shaped resistor 51a has a second width w2a in the short-side direction that is constant in the longitudinal direction. In the end region L1, the second strip-shaped resistor 51b has a third width w1b in the short-side direction, and the third width w1b varies according to the position in the longitudinal direction. In the central region L2, the second strip-shaped resistor 51b has a fourth width w2b in the short-side direction that is constant in the longitudinal direction. An end of the sheet P as the sheet-shaped member having a maximum width among the widths in the longitudinal direction of sheets used in the fixing device passes through a portion facing the end region L1 in the fixing nip. In other words, the end region L1 of the heater 23 faces the end of the sheet in the longitudinal direction of the heater 23, the sheet having the maximum width among the widths of sheets in the longitudinal direction passable in the fixing device 20.

A boundary between the end region L1 and the central region L2 is defined as a boundary P1. The region outside the boundary P1 in the longitudinal direction is defined as an end region in which obtaining a good fixing performance is difficult. Setting the boundary P1 at a certain specified position (the position at which enhancing the fixing performance is desired) in the image area and applying the embodiment of the present disclosure to the end region from the boundary P1 enhance the fixing performance.

The sum of the widths of the first strip-shaped resistor 51a and the second strip-shaped resistor 51b in the short-side direction is constant in the longitudinal direction. In other words, the sum (w1a+w1b) of the widths of the first strip-shaped resistor 51a and the second strip-shaped resistor 51b in the short-side direction in the end region L1 is constant in the longitudinal direction. The sum (w2a+w2b) of the widths of the first strip-shaped resistor 51a and the second strip-shaped resistor 51b in the short-side direction in the central region L2 is constant in the longitudinal direction.

The sum (w1a+w1b) in the end region L1 is equal to the sum (w2a+w2b) in the central region L2. Additionally, in the central region L2, the width w2a of the first strip-shaped resistor 51a in the short-side direction is equal to the width w2b of the second strip-shaped resistor 51b in the short-side direction (w1a=w1b).

Setting the constant widths t1 and t2 of the gap 60 to the minimum insulating distances (for example, 0.2 mm) minimizes the total width of a heat generation area. The above-described configuration minimizes both a width W1 of the end region L1 and a width W2 of the central region L2 in the short-side direction even in a case in which the nip width of the fixing nip need to be narrowed.

The above-described configuration can achieve both downsizing of the fixing device 20 and enhancing the fixing function.

In the end region L1 that is the left region in FIG. 5, the first width w1a of the first strip-shaped resistor 51a in the short-side direction linearly decreases toward the outside in the longitudinal direction. In other words, the first width w1a of the first strip-shaped resistor 51a linearly decreases toward the outer end of the first strip-shaped resistor 51a in the longitudinal direction. On the other hand, the third width w1b of the second strip-shaped resistor 51b in the short-side direction linearly increases toward the outside in the longitudinal direction. In other words, the third width w1b of the second strip-shaped resistor 51b linearly increases toward the outer end of the second strip-shaped resistor 51b in the longitudinal direction. In addition, the third width w1b of the second strip-shaped resistor 51b in the short-side direction is larger than the first width w1a of the first strip-shaped resistor 51a in the short-side direction over the entire end region L1. In the short-side direction, the end region L1 may be configured to gradually decrease the first width w1a and gradually increase the third width w1b instead of linearly decreasing the first width w1a and linearly increasing the third width w1b.

Accordingly, in the end region L1, the amount of heat generated per unit length in the longitudinal direction of the first strip-shaped resistor 51a is larger than the amount of heat generated per unit length in the longitudinal direction of the second strip-shaped resistor 51b. The above-described configuration prevents the temperature in the end region L1 heated by the strip-shaped resistors 51a and 51b from decreasing and prevents the temperature in a non-sheet passing region from excessively increasing. Further, linearly decreasing the first width w1a and linearly increasing the third width w1b in the short-side direction prevents the temperature in the end region from decreasing in the longitudinal direction and prevents the temperature in the non-sheet passing region from excessively increasing.

The above-described configuration applies heat from an upstream portion in the fixing nip to the sheet P bearing the unfixed toner and entering the fixing nip, which enhances the fixing performance. In other words, the above-described configuration effectively applies heat to the sheet P in an early stage in the fixing nip that is the only region where heat can be applied to the sheet P.

Setting the constant width t1 of a left part of the gap 60 in FIG. 5 to be equal to the constant width t2 of a right part of the gap 60 in FIG. 5 causes the width W1 (w1a+t1+w1b) in the end region L1 and the width W2 (w2a+t2+w2b) in the central region L2 to be the same width W in the short-side direction. This enables the strip-shaped resistors 51a and 51b to uniformly generate heat in the longitudinal direction. Since the above-described configuration does not have a relatively lower fixing performance region, the above-described configuration does not need to increase a setting temperature to obtain a necessary fixing performance in the relatively lower fixing performance region. As a result, the above-described configuration can enhance the energy saving performance.

Setting the center position C1 of the gap 60 to the position of W/2 as illustrated in FIG. 5 causes the amount of heat generated by the first strip-shaped resistor 51a in an upstream part of the fixing nip in the central region L2 to be equal to the amount of heat generated by the second strip-shaped resistor 51b in a downstream part of the fixing nip in the central region L2. As a result, the above-described configuration gives a good fixing performance with a good balance in the central region L2.

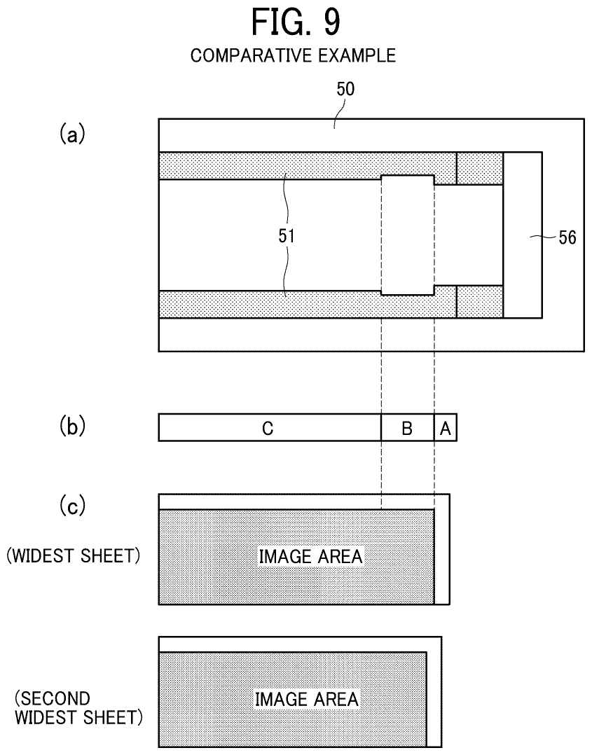

With reference to FIG. 9(a) to 9(c), a comparative example is described below. FIG. 9(a) is a plan view of the part from the center to the right end of a heater according to the comparative example. The heater illustrated in FIG. 9(a) includes strip-shaped resistors 51 having three regions A, B, and C, as illustrated in FIG. 9(b). These regions are related to the sheet conveyance region through which the widest sheet and the second widest sheet pass, as illustrated in FIG. 9(c). Since the resistance of the region B through which the end of the sheet passes is higher than the resistance of the other regions A and C, the amount of heat generated in the region B is increased. As a result, a temperature drop in the end region may be prevented. However, the amount of heat generation that is not uniform in the longitudinal direction causes the fixing performance to vary in the longitudinal direction.

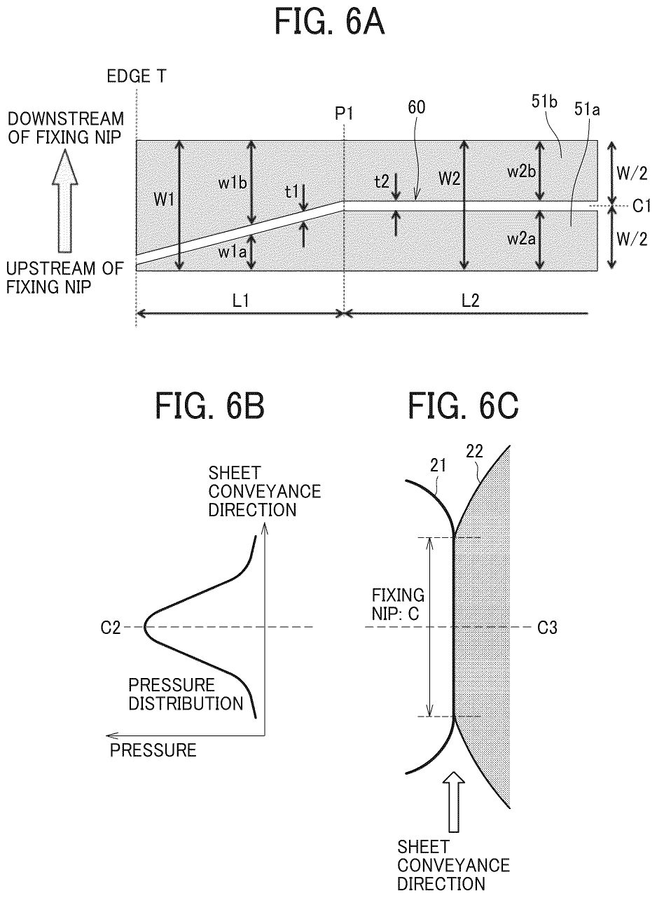

A second embodiment is described below with reference to FIGS. 6A to 6C.

FIG. 6A is a plan view of an end portion of a heater of a fixing device according to the second embodiment. FIG. 6B is a graph illustrating a pressure distribution of the fixing nip in the sheet conveyance direction. FIG. 6C is a schematic diagram illustrating the fixing nip between the fixing belt 21 and the pressure roller 22. As illustrated in FIG. 6A, the heater according to the second embodiment includes the first strip-shaped resistor 51a and the second strip-shaped resistor 51b. In the central region L2, the second constant width w2a of the first strip-shaped resistor 51a in the short-side direction is equal to the fourth constant width w2b of the second strip-shaped resistor 51b in the short-side direction. Additionally, in the central region L2, the center position C1 of the gap 60 in the short-side direction is set to the center position C2 of the fixing nip C in the sheet conveyance direction illustrated in FIG. 6B. As illustrated in FIG. 6B, the center position C2 is a peak position of the pressure distribution. The center position C2 of the fixing nip C in the sheet conveyance direction coincides with the pressure central position C3 of the pressure roller 22. In addition, the center of the heater in the short-side direction may be designed to coincide with the center position C2 of the fixing nip C. As a result, the gap 60 is at the center of the heater in the short-side direction in the central region L2.

In the central region L2, the above-described configuration applies equal and symmetrical surface pressures to the upstream part of the fixing nip including the first strip-shaped resistor 51a and the downstream part of the fixing nip including the second strip-shaped resistor 51b. As a result, the above-described configuration gives a good fixing performance with a good balance in the central region L2.

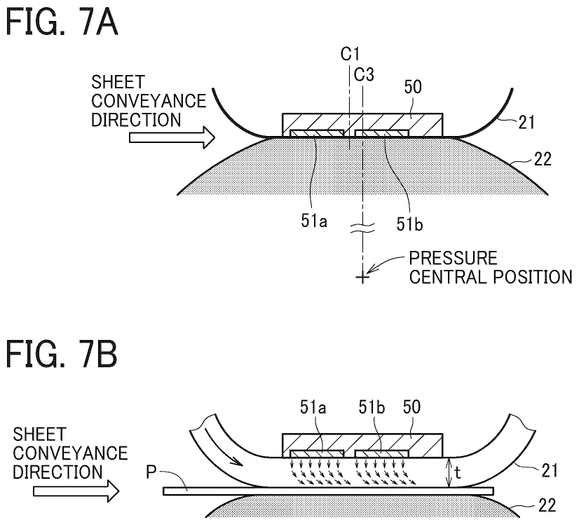

A third embodiment is described below with reference to FIGS. 7A and 7B.

FIG. 7A is a cross-sectional view of the fixing nip in a fixing device according to the third embodiment. As illustrated in FIG. 7A, the center position C1 of the gap 60 in the short-side direction is set to a position upstream from the pressure central position C3 of the pressure roller 22 in the sheet conveyance direction and inside the fixing nip. The pressure central position C3 of the pressure roller 22 in the sheet conveyance direction coincides with the center position C2 of the fixing nip C, and the center of the heater in the short-side direction may be designed to coincide with the center position C2 of the fixing nip C. As a result, the gap 60 is upstream from the center of the heater in the sheet conveyance direction in the central region L2. FIG. 7B is a schematic diagram of the fixing nip in which the thickness t of the fixing belt 21 is enlarged to highlight the thickness t of the fixing belt 21. Since the fixing belt 21 rotates in the direction indicated by an arrow in FIG. 7B, heat generated from the strip-shaped resistors 51a and 51b is transferred to the sheet P while being shifted to the downstream side in the sheet conveyance direction.

Since the heat transfer speed of the physical property is uniquely a fixed value, increasing the rotation speed of the fixing belt 21 or the thickness t of the fixing belt 21 shifts a position to which the heat is transferred downstream in the fixing nip. As a result, applying heat to the sheet P in the most upstream part of the fixing nip is difficult. In order to efficiently transfer heat within the limited width of the fixing nip, disposing the heat generating portion upstream in the fixing nip and applying heat to the sheet P earlier is desirable.

In order to apply heat of the strip-shaped resistors 51a and 51b to the sheet P at the center of the fixing nip, the strip-shaped resistors 51a and 51b in the third embodiment are positioned upstream in the sheet conveyance direction (the upstream part of the fixing nip) from the positions of the strip-shaped resistors 51a and 51b in the second embodiment illustrated in FIG. 6. As a result, the fixing device in the third embodiment can apply heat to the sheet earlier in the fixing nip. Since the above-described configuration does not have a relatively lower fixing performance region, the above-described configuration does not need to increase a setting temperature to obtain a necessary fixing performance in the relatively lower fixing performance region. As a result, the above-described configuration can enhance the energy saving performance.

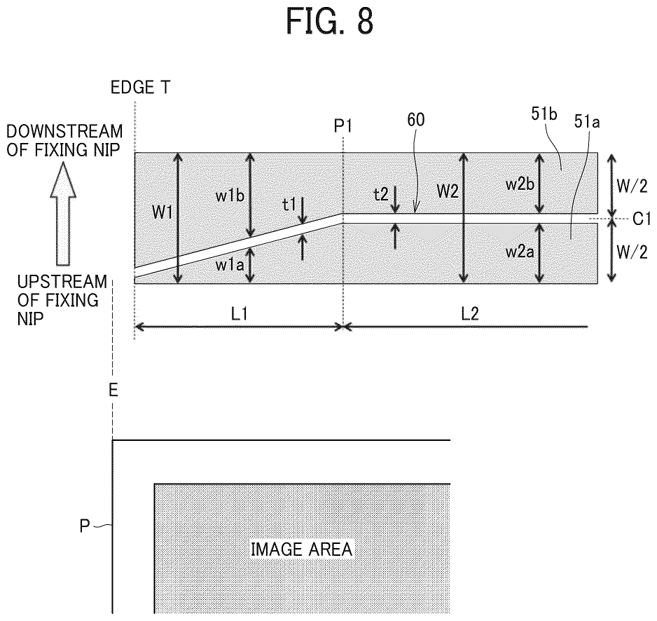

A fourth embodiment is described below with reference to FIG. 8.

FIG. 8 is a plan view of an end portion of a heater of a fixing device according to the fourth embodiment. As illustrated in FIG. 8, an end of a region to be heated on the sheet P (that is an image area) passes through the portion facing the end region L1 in the fixing nip in the fourth embodiment. In other words, the end region L1 of the heater faces the end of the region to be heated on the sheet-shaped member, in the longitudinal direction, having the maximum width among the widths of the sheet-shaped members in the longitudinal direction passible in the fixing device. Since a portion outside the region to be heated (that is the image area) of the sheet P (for example, the edge E of the sheet P) does not need to be heated, the ends of the strip-shaped resistors 51a and 51b can be set at positions inside from the positions of the ends of the strip-shaped resistors 51a and 51b in the embodiment of FIG. 5. This configuration can reduce the size of the fixing device 20.

When an edge T of a heat generator including the strip-shaped resistors 51a an 51b is outside from the edge E of the sheet, the heat generator heats a non-sheet-passing region outside the sheet P. In this case, continuously heating sheets each passing through the fixing nip to fix images onto the sheets may cause an abnormal temperature rise in the non-sheet-passing region.

To avoid the abnormal temperature rise in the non-sheet-passing region, the edge T of the heat generator is preferably inside the edge E of the sheet P. A margin portion that is not the image area is at an end portion of the sheet P. Preferably, the edge T of the heat generator is positioned in the margin portion.

The present disclosure has been described above on the basis of the embodiments, but the present disclosure is not limited to the embodiments. Needless to say, various alterations can be made in the scope of the technical idea described in the scope of the claims. For example, the first strip-shaped resistor 51a and the second strip-shaped resistor 51b may be connected in parallel instead of being connected in series. The first strip-shaped resistor 51a and the second strip-shaped resistor 51b may be formed in two rows, or in three, four, or five or more rows. The first strip-shaped resistor 51a and the second strip-shaped resistor 51b are minimum requirements, and various modified embodiments are possible as long as the first strip-shaped resistor 51a and the second strip-shaped resistor 51b are provided.

The following describes preferred aspects of the present disclosure.

### First Aspect

In a first aspect, the heating device has the following features. The heating device includes a pressure rotator, a heating rotator, and a heater. A nip is formed between the pressure rotator and the heating rotator. A heated member having a sheet shape passes through the nip in a sheet conveyance direction. A short-side direction is defined as the same direction as the sheet conveyance direction, and a longitudinal direction is defined as a direction orthogonal to the short-side direction. The heater includes a first strip-shaped resistor and a second strip-shaped resistor extending in two rows in the longitudinal direction inside the heating rotator. A gap having a constant width in the short-side direction is formed between the first strip-shaped resistor and the second strip-shaped resistor. In the longitudinal direction, the first strip-shaped resistor and the second strip-shaped resistor have a central region and an end region adjacent to the central region. In the central region, each of the first strip-shaped resistor and the second strip-shaped resistor has a constant width in the short-side direction. In the end region, the widths of the first strip-shaped resistor and the second strip-shaped resistor in the short-side direction vary. A sum of the widths of the first strip-shaped resistor and the second strip-shaped resistor in the short-side direction is constant in the longitudinal direction.

### Second Aspect

In a second aspect, the heating device according to the first aspect has the following features. The first strip-shaped resistor faces an upstream portion of the nip in the sheet conveyance direction. The second strip-shaped resistor faces a downstream portion of the nip in the sheet conveyance direction. The first strip-shaped resistor and the second strip-shaped resistor have a constant thickness. In the end region, the width of the first strip-shaped resistor in the short-side direction decreases toward an outside in the longitudinal direction. In the end region, the width of the second strip-shaped resistor in the short-side direction increases toward the outside in the longitudinal direction. In the end region, the width of the second strip-shaped resistor in the short-side direction is larger than the width of the first strip-shaped resistor in the short-side direction.

### Third Aspect

In a third aspect, the heating device according to the first aspect or the second aspect has the following feature. The gap in the central region is at a center of the heater in the short-side direction.

### Fourth Aspect

In a fourth aspect, the heating device according to the first aspect or the second aspect has the following feature. The gap in the central region is upstream in the sheet conveyance direction from a center of the heater in the short-side direction.

### Fifth Aspect

In a fifth aspect, the heating device according to the first aspect or the second aspect has the following feature. A longitudinal end of the heated member passes through a portion of the nip adjacent the end region.

### Sixth Aspect

In a sixth aspect, the heating device according to the first aspect or the second aspect has the following feature. A longitudinal end of a part to be heated on the heated member passes through a portion of the nip adjacent the end region.

### Seventh Aspect

In a seventh aspect, the heating device according to the first aspect or the second aspect has the following feature. The width of the first strip-shaped resistor in the short-side direction linearly decreases toward an outside in the longitudinal direction. The width of the second strip-shaped resistor in the short-side direction linearly increases toward the outside in the longitudinal direction.

### Eighth Aspect

In an eighth aspect, a fixing device includes the heating device according to any one of the first to seventh aspects.

### Ninth Aspect

In a ninth aspect, an image forming apparatus includes the fixing device according to the eighth aspect.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A heating device comprising:
a pressure rotator; and
a heating rotator having a loop and forming a nip between the pressure rotator and the heating rotator, the nip through which a sheet-shaped member passes in a sheet conveyance direction; and
a heater inside the loop of the heating rotator and extending in a longitudinal direction orthogonal to a short-side direction parallel to the sheet conveyance direction, the heater having:
a central region in the longitudinal direction; and
an end region adjacent to the central region in the longitudinal direction,
wherein the heater includes:
a first strip-shaped resistor extending in the longitudinal direction and having:
a first width in the short-side direction in the end region, the first width varying according to a position in the longitudinal direction; and
a second width in the short-side direction in the central region, the second width constant in the longitudinal direction; and
a second strip-shaped resistor extending in the longitudinal direction and having:
a third width in the short-side direction in the end region, the third width varying according to the position in the longitudinal direction; and
a fourth width in the short-side direction in the central region, the fourth width constant in the longitudinal direction,
a gap between the first strip-shaped resistor and the second strip-shaped resistor in the short-side direction, the gap constant in the longitudinal direction, and
a sum of the first width and the third width at the position in the longitudinal direction in the end region is equal to a sum of the second width and the fourth width in the central region.

2. The heating device according to claim 1,
wherein the first strip-shaped resistor is disposed upstream from the second strip-shaped resistor in the sheet conveyance direction,
each of the first strip-shaped resistor and the second strip-shaped resistor has a constant thickness that is constant along the sheet conveyance direction,
the first width of the first strip-shaped resistor decreases toward an outer end of the first strip-shaped resistor in the longitudinal direction in the end region,
the third width of the second strip-shaped resistor increases toward an outer end of the second strip-shaped resistor in the longitudinal direction in the end region, and
the third width is larger than the first width at the position in the longitudinal direction in the end region.

3. The heating device according to claim 2,
wherein the gap is at a center of the heater in the short-side direction in the central region.

4. The heating device according to claim 2,
wherein the gap is upstream from a center of the heater in the sheet conveyance direction in the central region.

5. The heating device according to claim 2,
wherein the end region of the heater faces an end of the sheet-shaped member, in the longitudinal direction, having the maximum width among widths of the sheet-shaped members in the longitudinal direction passable in the heating device.

6. The heating device according to claim 2,
wherein the end region of the heater faces an end of a region to be heated on the sheet-shaped member, in the longitudinal direction, having the maximum width among widths of the sheet-shaped members in the longitudinal direction passible in the heating device.

7. The heating device according to claim 2,
wherein the first width of the first strip-shaped resistor linearly decreases toward the outer end of the first strip-shaped resistor in the longitudinal direction, and
the third width of the second strip-shaped resistor linearly increases toward the outer end of the second strip-shaped resistor in the longitudinal direction.

8. A fixing device comprising the heating device according to claim 1.

9. An image forming apparatus comprising the fixing device according to claim 8.
